(19) United States
(12) Patent Application Publication
(10) Pub. No.: US 2004/0227004 A1
(43) Pub. Date: Nov. 18, 2004

(54) Concealed misting device

(76) Inventors: Greg Schutte, Mantoloking, NJ (US); Jeff Robbins, Singer Island, FL (US)

Correspondence Address: MUSERLIAN AND LUCAS AND MERCANTI, LLP, 475 PARK AVENUE SOUTH, NEW YORK, NY, 10016, US

(21) Appl. No.: 10/439,758

(22) Filed: May 16, 2003

(51) Int. Cl. B05B 17/08

(52) U.S. Cl. 239/17

(57) ABSTRACT

Decoration including a container defining a water-receiving receptacle and having an opening and a concealed misting device arranged in the receptacle for generating mist upon contact with water such that when water is present in the receptacle in contact with the misting device, mist is created and exits the container through the opening. The container can be in the form of a pumpkin, a mushroom, a witch with a cauldron, a fountain. and a tombstone. By providing a misting device in connection with structure which provides a frightful impression, a more frightening impression is created.

### FIELD OF THE INVENTION

The present invention relates generally to garden and exterior ornaments including misting devices which generate mist.

The present invention also relates to decorative misting devices and more particularly to objects for use on Halloween having a concealed misting device so that the mist creates a realistic, frightening impression in connection with the Halloween object.

### BACKGROUND OF THE INVENTION

On Halloween, objects are often placed in yards and other locations visible to the public which are designed to frighten viewers. Such objects may have the shape and form of ghosts, goblins, witches alone or with cauldrons, gnomes, tombstones and the like. To create the frightening impression, the objects are made to look as realistic as possible.

Pumpkins with scary faces are also usually made for Halloween and placed in locations visible to the public for the same purpose.

In gardens, ornamental objects are often placed having various shapes. Generally, such ornaments are passive in that they do not provide any benefit to the garden but only serve a decorative purpose. It would be beneficial if a watering or misting function were imparted to such ornaments.

### OBJECTS AND SUMMARY OF THE INVENTION

It is an object of the present invention to improve the frightening impression provided by decorations for use on Halloween and other occasions.

It is another object of the present invention to provide new decorations for use on Halloween and other occasions which create a more frightening impression than existing Halloween decorations.

It is still another object of the present invention to provide new decorations for use on Halloween and other occasions incorporating a misting device. When the decoration is of a form used for Halloween, for example, a pumpkin, a ghost, a goblin, a gravestone and a witch, then the generation of mist by the misting device conveys a more realistic, frightening impression.

It is yet another object of the present invention to provide new decorations incorporating a misting device with an interchangeable display so that multiple displays can be used with the decorations, possibly a different one for different holidays.

It is still another object of the present invention to provide a new and improved garden ornament which includes a concealed misting device and thus provides beneficial watering to surrounding vegetation.

In order to achieve these objects and others, a decoration in accordance with the invention includes a container defining a water-receiving receptacle and having an opening and a misting device arranged in the receptacle for generating mist upon contact with water such that when water is present in the receptacle in contact with the misting device, mist is created and exits the container through the opening.

The container can have many different forms. In one embodiment, the container is in the form of a pumpkin and includes an aperture in the form of a mouth, an aperture in the form of a nose and/or two apertures in the form of eyes. As such, the mist created by the misting device exiting through these apertures. In this case, a cover is provided to fit in the opening and leave a portion of the opening uncovered, whereby the uncovered portion constitutes an access aperture for enabling passage of an electrical power cord into an interior of the container.

The misting device may be fixed or detachably secured to a bottom surface of the container defining the receptacle. Instead of using a cord for coupling the misting device to an external power supply, a battery may be arranged in the container and coupled to the misting device for supplying electricity to the misting device.

The misting device may include a plurality of lights on an upper surface for illuminating an interior of the container. The lights can have different colors and be arranged to illuminate one color at a time.

In another embodiment, the opening is formed at a top of the container and the container further includes an aperture in a front face. A decorative member is arranged to cover the aperture in the front face of the container. The decorative member may be detachably fastened to the container so that different decorative members, each having a different seasonal motif, can be used with the decoration at the appropriate time.

Other shapes and forms of the container include a mushroom, a witch with a cauldron, a fountain. and a tombstone.

By providing a misting device in connection with structure which provides a frightful impression, a more frightening impression is created. For example, a tombstone from which mist is released at night is significantly more frightening than a simple tombstone. The difference is that both an active fright-providing feature (the mist) and a passive fright-providing feature (the tombstone) are combined in the invention whereas the simply presence of a passive fright-providing feature (the tombstone) as in the prior art does not convey the same degree of fright.

In another embodiment, the container is made of a buoyant material and the housing of the container has a channel with an inlet for receiving water from a body of water in which the decoration is placed and in flow communication with the receptacle. Water des not need to be poured into the receptacle but rather, the water is obtained from the body of water in which the housing is placed by flowing through the inlet and channel into the receptacle.

The container can also have the form of various garden ornaments so that when placed in a garden and generating mist, the mist serves to water surrounding vegetation. In one embodiment of a garden ornament, the container has the form of a frog with a mist exiting aperture formed in the mouth of the frog so that mist is released from the container through the frog's mouth. The back of the frog includes the water inlet opening and a cover is provided to cover this opening. In another embodiment, the container has the form of a lighthouse with a tower portion and a base portion with the water inlet opening being formed at the bottom of the tower portion for pouring water into a receptacle formed in the base portion of the lighthouse. Misting exiting openings are arranged around the base portion of the lighthouse through which the generated mist exits.

### BRIEF DESCRIPTION OF THE DRAWINGS

The invention, together with further objects and advantages thereof, may best be understood by reference to the following description taken in conjunction with the accompanying drawings wherein like reference numerals identify like elements.

FIG. 1 is a plan view of a pumpkin including a misting device in accordance with the invention.

FIG. 2A is a view of the rear of the pumpkin shown in FIG. 1.

FIG. 2B is an exploded view of the rear of the pumpkin shown in FIG. 1.

FIG. 3 is a view taken along the line 3-3 of FIG. 1 showing the misting device.

FIG. 4 is a cross-sectional view taken along the line 4-4 in FIG. 3 showing the submersion of the misting device in a receptacle defined by the pumpkin.

FIG. 5 is a front perspective view of another embodiment of a decoration having a misting device for use with several displays in accordance with the invention.

FIG. 6 is a cross-sectional view of the decoration shown in FIG. 5 taken along the line 6-6.

FIG. 7 is a perspective view of another embodiment of a decoration having a misting device in accordance with the invention.

FIG. 8 is a top view of another decoration having a misting device in accordance with the invention.

FIG. 9 is a cross-sectional view of the decoration shown in FIG. 8 taken along the line 9-9.

FIG. 10 is a front view of yet another decoration having a misting device in accordance with the invention.

FIG. 11 is a front view of still another decoration having a misting device in accordance with the invention.

FIG. 12 is an exploded view of an embodiment of a decoration having a misting device for use in gardens in accordance with the invention.

FIG. 13 is a cross-sectional view of the decoration shown in FIG. 12.

FIG. 14 is a front view of still another embodiment of a decoration having a misting device for use in gardens in accordance with the invention.

### DETAILED DESCRIPTION OF THE INVENTION

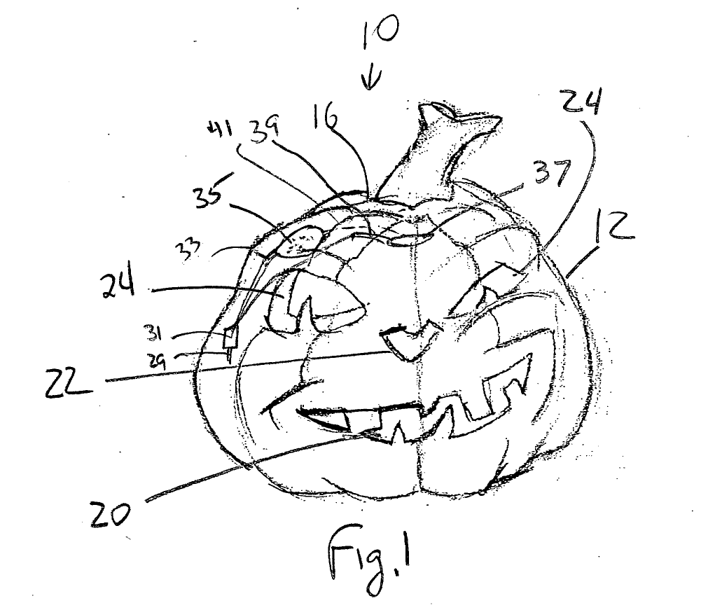

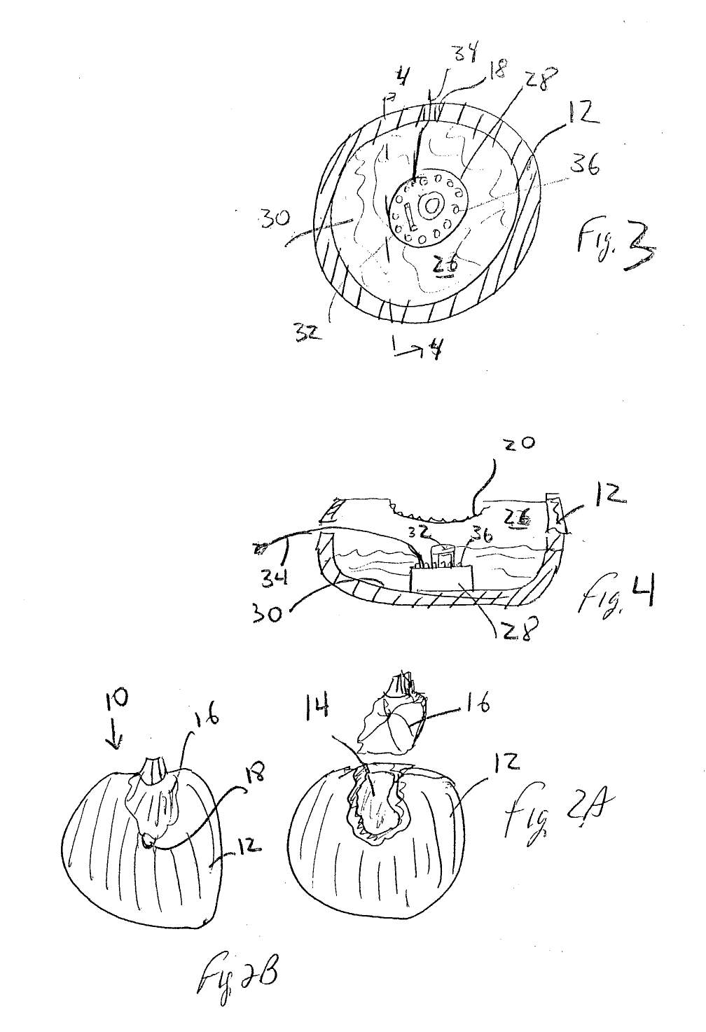

Referring to the accompanying drawings wherein like reference numbers refer to the same or similar elements, FIGS. 1-4 show a pumpkin including a misting device in accordance with the invention and is designated generally as 10. The pumpkin 10 is representative of a type of object which is appropriate for use on Halloween. Other objects including a misting device in accordance with the invention are mentioned below.

The pumpkin 10 includes a container 12 in the shape of a pumpkin and having an opening 14 on a rear side and a cover 16 in the shape of a leaf and a stem which is designed to fit in the opening 14. When the cover 16 is placed in the opening 14, substantially the entire opening 14 is covered except for an access aperture 18 (see FIG. 2B). The cover 16 may be pivotally connected to the container 12.

The container 12 has apertures in the form of a mouth 20, a nose 22 and eyes 24 on a front side. The mouth 20 is the lowermost aperture, lower than the nose 22, eyes 24 and access aperture 18, and is spaced a distance from the inner, bottom surface of the container 12 to enable the formation of a receptacle 26 in the container 12 in which water can be retained (see FIG. 4). Also, although the entire container 12 can be formed from a non-porous material, at a minimum, the inner surface of the container 12 is formed from a non-porous material so that any water in the receptacle 26 will not leak out of the container 12.

The pumpkin 10 also includes a misting device 28 arranged in the receptacle 26. The misting device 28 may be fixed to the lower surface 30 of the container 12 or detachably secured to the lower surface 30 the container 12 The misting device 28 may be a known misting device including a heatable element 32 having a surface against which water is present such that the water is heated and mist is formed. An electrical power supply cord 34 is connected to the misting device 28 to heat the heatable element 32. When the cord 34 is plugged into an outlet, the heatable element 32 is heated and when contacted by water, mist is formed.

Instead of a power supply cord 34 for supplying the misting device 28 with electricity from an external source, a battery compartment can be provided in the container 12 and/or alongside the misting device 28 to supply power to the misting device 28.

When the misting device 28 is detachable from the container 12, the opening 14 is dimensioned to be large enough to enable the placement of the misting device 28 in the receptacle 26 of the container 12. Also, the access aperture 18 is designed such that the cord 34 for the misting device 28 can pass through the access aperture 18 to be connected to the outlet (see FIG. 4).

In use, the misting device 28 is placed through the opening 14 onto the lower surface of the container 12, if not fixed thereto, and the cord 34 is passed through the access aperture 18 and connected to an outlet. Water is poured through the opening 14 into the receptacle 26 until it covers the misting device 28. As the heatable element 32 heats up, the water coming into contact with the heatable element 32 turns to mist. The mist passes through the mouth 20, nose 22 and eyes 24 of the container 12 to create a frightening impression of a misty pumpkin.

Different misting devices 28 can be designed for use in the invention. As shown, the misting device 28 includes a ring of lights 36 on an upper surface. These lights 36 light up when the misting device 28 is powered so that the interior of the pumpkin 10 is illuminated further enhancing the frightening effect of the decoration.

The lights 36 can have different colors and controlled so that lights of only one color light up at the same time. Thus, the illumination in the interior of the pumpkin can be yellow for a set period of time, then red, then green, then yellow again. Other patterns of light and color schemes can be used in accordance with the invention.

The misting device 28 can also be designed to be operated by remote control. This would entail including a wireless receiver in association with the misting device 28 or the electrical power supply thereto and would enable control the misting device 28 upon transmission of a signal from the remote control device. The remote control device would then be used to cause the misting device 28 to function or stop functioning.

A motion sensor 37 could also be built into the container 12, preferably in a front of the container 12 as shown in FIG. 1. A sound system 35, e.g., a speaker, can also be built into the container 12, preferably in the front of the container as shown in FIG. 1. The motion sensor 37 would be coupled to the sound system 35 by a wire or wireless connection (represented schematically by wire 41) so that when motion in the effective field of the motion sensor 37 is detected, the sound system 25 is activated to begin functioning. Motion sensor 37 may be powered by a battery or via an electrical connection to the power cord 34. The sound system 35 could also be coupled to the electrical supply.

A control unit 31 for the misting device 28, sound system 35 and motion sensor can be provided to couple these components together, e.g., via wires 33,39. Such a control unit can be built into the misting device 28 or be separate therefrom as shown in FIG. 1 and coupled to the misting device 28 through a wire (represented schematically by 29). The control unit 31 would activate the sound system 35 when motion is detected. It could also include the receiver to enable receipt of signals from the remote control unit to then activate the sound system 35 and/or misting device 28.

Referring now to FIGS. 5 and 6, a second embodiment of a decoration in accordance with the invention is shown. The decoration 38 comprises a container 40 having an opening 42 formed at its top and an aperture 44 formed in the front side 46. An access aperture 48 is formed preferably in the rear side 50 of the container 40 to enable passage of an electrical power cord 52 to power a misting device 54 fixed to the lower surface 56 of the container 40 or detachably secured to the lower surface 56 of the container 40. Instead of a power cord 52 for supplying the misting device 54 with electricity from an external source, a battery compartment can be provided in the container 40 and/or alongside the misting device 54 to supply power to the misting device 54.

A receptacle 58 is defined in the container 40 below the access aperture 48 and the aperture 44 in the front side 46 of the container 40 in which water can be retained. Although the entire container 40 can be formed from a non-porous material, at a minimum, the lower surface 56 of the container and the inner, side surfaces below the apertures 44,48 should be formed from a non-porous material so that any water in the receptacle 58 will not leak out of the container 40.

As shown, the container 40 has a generally rectangular cross-sectional shape. Other cross-sectional shapes can be used in accordance with the invention. The aperture 44 should be placed in the front of the container 40, regardless of its cross-sectional shape and the access aperture 48 should be placed at the rear of the container 40 so that it will not be visible from the front.

The container 40 can also be made to appear as a tombstone with writing on the front face instead of the aperture 44.

In use, the misting device 54 is placed through the opening 42 onto the lower surface 56 of the container 40, if not fixed thereto, and the cord 52 is passed through the access aperture 48 and connected to an outlet. Water is poured through the opening 42 into the receptacle 58 until it covers the misting device 54. As the heatable element of the misting device 54 heats up, the water coming into contact with the heatable element turns to mist. The mist passes through the opening 42 as well as through the aperture 44.

In this embodiment, a decorative member 60 is detachably secured in the aperture 44 and has a motif which may be specific to a holiday. For example, one decorative member 60a may have a Halloween motif, another decorative member 60b may have a Christmas motif, another decorative member 60c may have a spring motif and another decorative member 60d may have a fall motif The container 40 can thus be used throughout the year by inserting the seasonal appropriate decorative member 60 in the aperture 44.

The specific manner in which the decorative member 60 is placed in the aperture 44 may be by the use of fasteners such as screws. The decorative member 60 is placed in an indentation 62 surrounding the aperture 48 and fixed to the container 40 by the screws 63. Other fasteners may also be used on the invention.

The misting device 54 may be the same as the misting device 28 with any or all of the possible modifications described above.

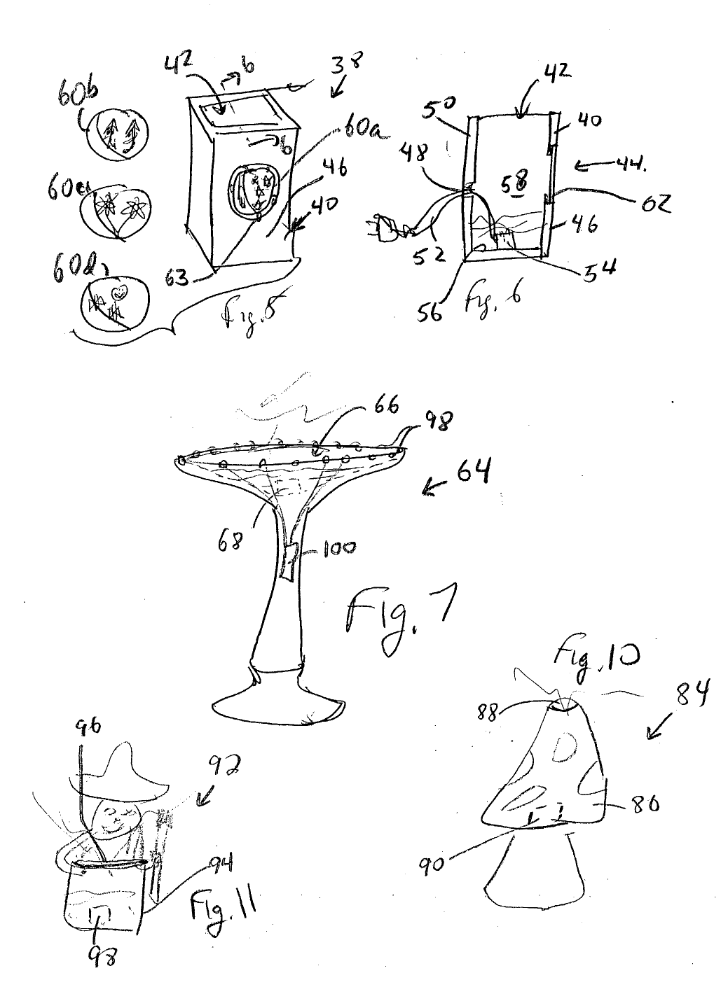

FIG. 7 shows another embodiment of the invention designated generally as 64. The decoration has the form of a fountain with a water-receiving receptacle 66 formed at the top. A misting device 68 is fixed to the lower surface defining the receptacle 66 or detachably secured thereto. The receptacle 66 is then filled with water to cover the misting device 68 and cause water to contact the heatable element of the misting device 68.

Lights 98 are built into the edge of the rim defining the receptacle 66 and coupled to an electrical power supply, such as battery 100. The lights are colored and can be arranged to illuminate one color at a time.

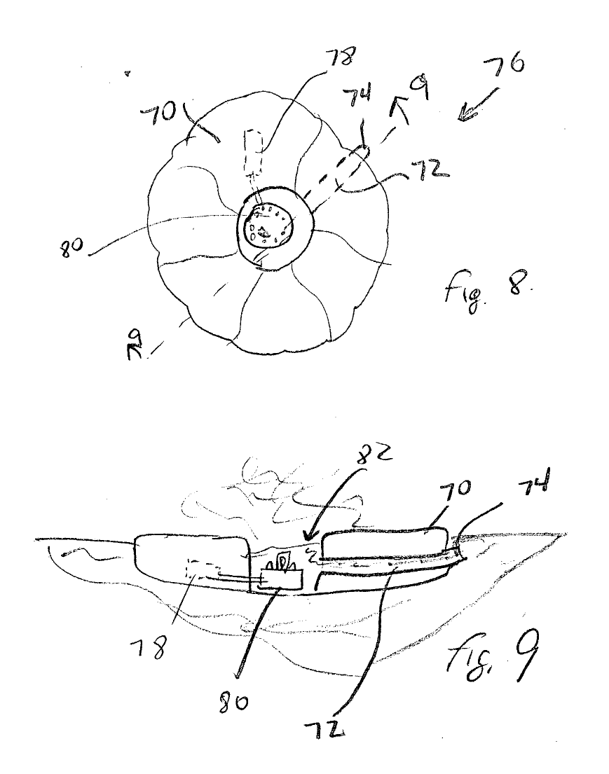

Referring now to FIGS. 8 and 9, this embodiment of a decoration is in the form a lily pad 76 which is made of a buoyant material to enable it to float on the surface of water, e.g., in a pond. The housing 70 of the lily pad includes a channel 72 with an inlet 74 for receiving water from the pond and a misting device 80 of the type described above. A battery 78 is arranged in the housing 70 to provide electrical power to the misting device 80 arranged in a central receptacle 82.

In use, water flows into the inlet 74 and through the channel 72 to the central receptacle 82 in which the misting device 80 is situated. The water comes into contact with the heatable element of the misting device 80 and turns to mist which is released through the top of the receptacle 82.

FIG. 10 shows another embodiment of the invention designated generally as 84. The decoration has a housing 86 having the shape and form of a mushroom with a water-receiving receptacle formed in the interior and an opening 88 at the top. A misting device 90 is fixed to the lower surface defining the receptacle or detachably secured thereto. A battery may be arranged in the housing 86 to provide electrical power to the misting device 90.

In use, the receptacle is filled with water through opening 88 to cover the misting device 90 and cause water to contact the heatable element of the misting device 90 to create mist. The mist is released from the interior of the housing 86 through opening 88.

FIG. 11 shows another embodiment of the invention designated generally as 92. The decoration has a housing 94 having the shape and form of a witch with a cauldron with a water-receiving receptacle formed in the cauldron and an opening 96 at the top of the cauldron. A misting device 98 is fixed to the lower surface defining the receptacle or detachably secured thereto. A battery may be arranged in the housing 94 to provide electrical power to the misting device 98.

In use, the receptacle is filled with water through opening 96 to cover the misting device 98 and cause water to contact the heatable element of the misting device 98 to create mist. The mist is released from the interior of the housing 94 through opening 96. As such, it appears that the mist is rising from a “witch's brew” in the cauldron.

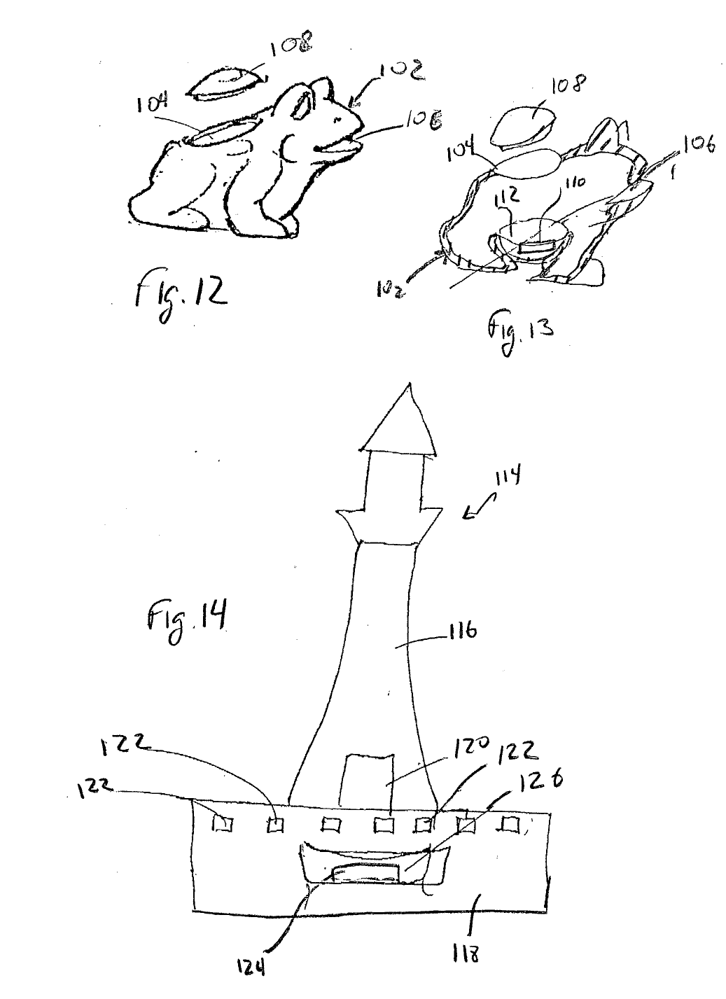

Referring now to FIGS. 12 and 13, a first embodiment of a garden ornament in accordance with the invention is shown as 102. The ornament 102 is in the form of a frog-shaped container defining an interior receptacle and includes a water inlet opening 104 and a mist exiting opening 106. The water inlet opening 104 is on a back of the frog-shaped container 102 and a cover 108 fits into the opening 104. The mist exiting opening 106 is formed in a mouth of the frog-shaped container 102. The bottom surface of the frog-shaped container 102 is designed to be placed on a flat surface so that the frog-shaped container is stable.

A misting device 110 is arranged in the receptacle 112 to generate mist upon contact with water such that when water is present in the 112 receptacle in contact with the misting device 110, mist is created and exits the frog-shaped container through the mist exiting opening 106. When used in a garden, the generated mist provides water to the surrounding vegetation.

FIG. 14 shows another embodiment of a garden ornament 114 in the form of lighthouse having a tower portion 116 and a base portion 118. A water inlet opening 120 is arranged at a bottom of the tower portion 116 and several mist exiting openings 122 are formed at a top of the base portion 118. A misting device 124 is placed in the receptacle 126 in the base portion 118.

In both of the garden ornament embodiments, power to the misting device 110,124 may be provided by a battery or by means of an electrical cord. The battery is preferred as the garden ornament can thus be a stand-alone product.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

We claim:

1. A decoration, comprising:
a container defining a water-receiving receptacle and having at least one opening; and
a misting device arranged in said receptacle for generating mist upon contact with water such that when water is present in said receptacle in contact with said misting device, mist is created and exits said container through said at least one opening.

2. The decoration of claim 1, wherein said container is in the form of a pumpkin and said at least one opening includes at least one of an aperture in the form of a mouth, an aperture in the form of a nose and two apertures in the form of eyes, the mist created by said misting device exiting through said at least one aperture.

3. The decoration of claim 1, further comprising a cover arranged to fit in a first one of said at least one opening and leave a portion of said first opening uncovered, the uncovered portion of said first opening constituting an access aperture for enabling passage of an electrical power cord into an interior of said container.

4. The decoration of claim 1, wherein said misting device is fixed to a bottom surface of said container defining said receptacle.

5. The decoration of claim 1, wherein said misting device is detachably secured to a bottom surface of said container defining said receptacle.

6. The decoration of claim 1, further comprising a battery arranged in said container and coupled to said misting device for supplying electricity to said misting device.

7. The decoration of claim 1, wherein said misting device includes a plurality of lights on an upper surface for illuminating an interior of said container.

8. The decoration of claim 7, wherein said lights have different colors and are arranged to illuminate one color at a time.

9. The decoration of claim 1, wherein said at least one opening includes a water inlet opening formed at a top of said container and a mist exiting opening in a front face, further comprising a decorative member arranged to cover said mist exiting opening in said front face of said container.

10. The decoration of claim 9, further comprising fastening means for detachably fastening said decorative member to said container.

11. The decoration of claim 9, wherein said container has a rectangular cross-sectional shape.

12. The decoration of claim 9, further comprising a plurality of decorative members, each having a different motif.

13. The decoration of claim 1, wherein said container is in the form of a fountain.

14. The decoration of claim 13, wherein said container includes a rim defining said receptacle, further comprising lights arranged in said rim.

15. The decoration of claim 14, wherein said lights have different colors and are arranged to illuminate one color at a time.

16. The decoration of claim 1, wherein said container is made of a buoyant material.

17. The decoration of claim 16, wherein said container includes a housing having a channel in communication with a first one of said at least one opening serving as a water inlet opening for receiving water from a body of water in which the decoration is placed and in flow communication with said receptacle.

18. The decoration of claim 1, wherein said container is in the form of a mushroom and said at least one opening is formed at a top of said container.

19. The decoration of claim 1, wherein said container is in the form of a witch with a cauldron and said at least one opening is formed at a top of said cauldron.

20. The decoration of claim 1, further comprising a motion sensor and a sound system arranged in connection with said container, said sound system being controlled to generate sound when motion is detected by said motion detector.

21. A decoration for placement in a garden, comprising:
a container defining a water-receiving receptacle and having a water inlet opening and at least one mist exiting opening; and
a misting device arranged in said receptacle for generating mist upon contact with water such that when water is present in said receptacle in contact with said misting device, mist is created and exits said container through said at least one mist exiting opening.

22. The garden decoration of claim 21, wherein said container has the form of a frog and said water inlet opening is on a back of said frog, further comprising a cover arranged to fit in said water inlet opening, said at least one mist exiting opening being formed in a mouth of said frog.

23. The garden decoration of claim 21, wherein said container has the form of a lighthouse having a tower portion and a base portion and said water inlet opening is arranged at a bottom of said tower portion, said at least one mist exiting opening being formed at a top of said base portion.
